(19) United States
(12) Patent Application Publication
(10) Pub. No.: US 2004/0047335 A1
(43) Pub. Date: Mar. 11, 2004

(54) Wireless local area network extension using existing wiring and wireless repeater module(s)

(76) Inventors: James Arthur Proctor JR., Melbourne Beach, FL (US); Kenneth Marvin Gainey, Satellite Beach, FL (US)

Correspondence Address: POSZ & BETHARDS, PLC, 11250 ROGER BACON DRIVE, SUITE 10, RESTON, VA, 20190, US

(21) Appl. No.: 10/465,817

(22) Filed: Jun. 20, 2003

Related U.S. Application Data
(60) Provisional application No. 60/390,091, filed on Jun. 21, 2002.
(60) Provisional application No. 60/390,094, filed on Jun. 21, 2002.

(51) Int. Cl. H04L 12/28

(52) U.S. Cl. 370/351; 370/404

(57) ABSTRACT

A wireless area network (99) includes at least one access point (100), provides for multiple possible network devices (104, 105), and is located in a structure (108) with wiring (201). The wireless area network includes an interface unit (200) that extends the range of the network devices (104, 105). The interface unit (200) is for receiving wireless signals from the access point (100) and for transmitting the wireless signals on the wiring (201). The interface unit (200) is also for receiving the wireless signals from the wiring (201) and for transmitting the wireless signals to the access point (100).

### CROSS REFERENCE TO RELATED APPLICATIONS

This application is related to and claims priority from pending U.S. Provisional Application Nos. 60/390,091 and 60/390,094, filed on Jun. 21, 2002, the contents of which are incorporated herein by reference.

### FIELD OF THE INVENTION

The present invention relates generally to wireless communications, and particularly to wireless local area networks.

### BACKGROUND OF THE INVENTION

Several standard protocols for wireless local area networks, commonly referred to as WLANs, are becoming popular. These include protocols such as 802.11 (as set forth in the 802.11 wireless standards), home RF, and Bluetooth. The standard wireless protocol with the most commercial success to date is the 802.11b protocol.

While the specifications of products utilizing the above standard wireless protocols commonly indicate data rates on the order of, for example, 11 MBPS and ranges on the order of, for example, 100 meters, these performance levels are rarely, if ever, realized. This lack of performance is due to attenuation of the radiation paths of RF signals, which are typically in the range of 2.4 GHz, in an indoor environment. Base to receiver ranges are generally less than the coverage range required in a typical home, and may be as little as 10 to 15 meters. Further, in structures that have split floor plans, such as ranch style or two story homes, or that are constructed of materials that attenuate RF signals, areas in which wireless coverage is needed may be physically separated by distances outside of the range of, for example, an 802.11 protocol based system. Finally, the data rates of the above standard wireless protocols are dependent on the signal strength. As distances in the area of coverage increase, wireless system performance typically decreases.

Therefore, what is needed is a way to extend WLAN coverage in environments in which coverage is normally limited.

### SUMMARY OF THE INVENTION

Accordingly, the present invention provides an interface unit that extends coverage in a wireless environment such as a WLAN environment. The interface unit is cabled to a transceiver, such as an 802.11 access point and includes a matching circuit that interfaces with, for example, the wiring of a standard wall power outlet, or with other cabling or wiring present within a structure, and that couples 802.11 signals transmitted to and received from the access point over the wiring with no translation in RF frequency.

The interface unit may be a bidirectional unit capable of utilizing a switched receive and transmit amplification of signals to and from the access point. However, an increased signal level may only be needed on the return link, as the strength of a signal transmitted from a WLAN transceiver device such as a network device is typically significantly less than that of a signal transmitted from the access point, as a network device is typically battery operated and therefore minimization of power consumption is a key consideration. Therefore, the signal may be received by the access point over a wired connection to the wiring, and a receive only module may be located near the network device.

In another embodiment, the interface unit may provide an up/down conversion function that provides for the interface to the wiring at an intermediate frequency. Note that a bi-directional amplification capability may be used regardless of whether an up/down conversion is executed. Since WLAN protocols are typically time division duplex based protocols, the amplification need only be in a single direction at any given time. Therefore, the amplification may normally be enabled in one direction, and, when a sufficient signal is detected in the other direction, the first direction of amplification will be disabled and the opposite direction of amplification enabled.

The above amplification may be performed with a single switched amplifier or with two amplifiers that are enabled or disabled. However, a single switched amplifier is the preferred embodiment, as it provides for a reduced product cost. The detection process may be executed by a simple band-limited power detector. The “normal direction” of amplification will be from the antenna to the wired network for all modules, as the RF signal coupled to the antenna will be weaker than the re-amplified signal from the wires.

### BRIEF DESCRIPTION OF THE DRAWINGS

FIG. 1 is a schematic drawing showing a wireless wide area network including an interface unit to extend the range of the network.

FIG. 2 is a schematic drawing of the interface unit of FIG. 1.

FIG. 3 is a schematic drawing of a bi-directional amplification circuit within the interface unit of FIG. 2.

FIG. 4 is schematic of an alternative amplification circuit.

FIG. 5 is a schematic drawing of a switchable amplification circuit.

FIG. 6 is a schematic drawing of an alternative switchable amplification circuit.

FIG. 7 is a more detailed schematic of cable/wiring interface electronics used with the interface unit of FIG. 1.

FIG. 8 shows a wireless wide area network similar to that shown in FIG. 1 but including multiple interface units.

FIG. 9 is a schematic of an interface unit utilizing up and down conversion of a wireless wide area network signal to an intermediate frequency.

### DETAILED DESCRIPTION OF THE INVENTION

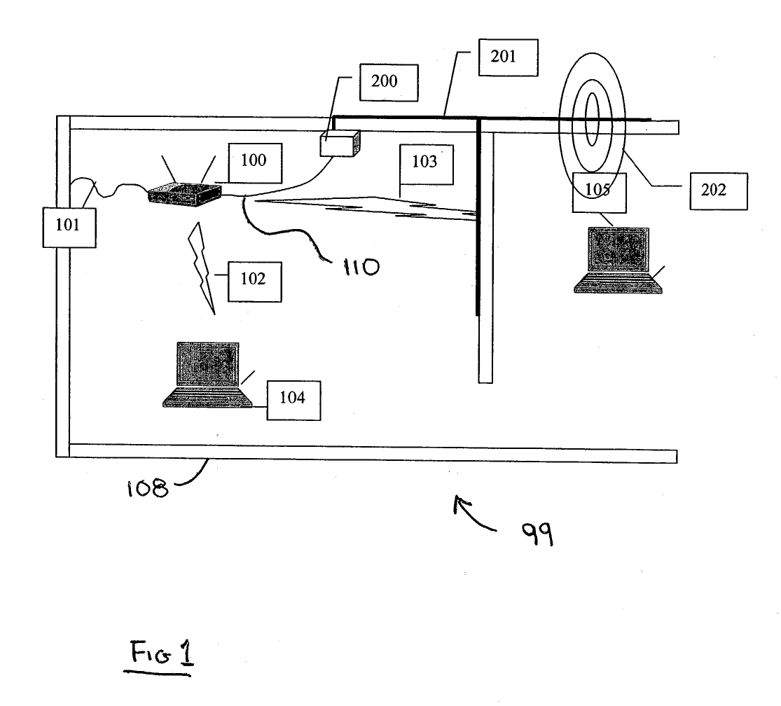

Referring to FIG. 1, an exemplary wireless local area network (WLAN) is shown at 99. The WLAN 99 includes a wireless gateway (access point) 100 connected to a wide area connection 101. The access point 100 transmits signals, such as RF signals, to exemplary network devices 104, 105 which may be any type of wireless communication devices capable of transmitting and/or receiving RF signals transmitting IEEE 802.11 packets or, alternatively, signals based on Bluetooth, Hyperlan, or other wireless communication protocols. However, for purposes of discussion, these signals will be referred to as RF signals. Propagation paths to each of the network devices 104, 105 are shown as signal paths 102, 103, respectively. Here, the RF signal carried over the signal path 102 is sufficient to maintain high speed data packet communications. However, the signal path 103 attenuates an RF signal intended for the network device 105 to a point where few, if any, data packets are received in either direction.

Still referring to FIG. 1, an interface unit 200, may also known as an interface module, distribution node or, more specifically, a power interface unit when it is connected to existing wiring 201 within a structure 108 such as an office building or a home. Those of ordinary skill in the art will recognize that the interface unit 200 may be connected to other suitable wiring in a structure, including but not limited to Ethernet cable, power lines, CAT5 cable, television cable, coaxial cable, telephone wires or the like. However, for purposes of discussion, the wiring 201 will be referred to throughout as structural wiring 201.

The interface unit 200 takes an RF signal interfaced from access point 100 by a cable (interface cable) 110 and receives and transmits the RF signal over the structural wiring 201. The RF signal is then radiated from the structural wiring 201 based on the natural radiation properties of the power lines 20 to establish a communication link between the access point 100 and the network device 105. Preferably, no intermediate frequency is used to establish the communication link. Instead, the RF signal is maintained at the original frequency carrier as if the signal is transmitted wirelessly on the signal path 103.

The interface unit 200 may also be designed to amplify RF signals in one or both directions to or from the network device 105. If the interface unit 200 amplifies these RF signals in both directions, the amplification function in each direction may only be enabled in one direction at a time based on a power threshold detection circuit (not shown) as is well known to those skilled in the art. Power detectors, network devices and access points are described in detail in pending International Application No. PCT/US 03/16208, which claims priority from Provisional Patent Application No. 60/390,093, the contents of which are incorporated by reference herein. The transmitted signal from the access point 100 will trigger the amplification process in the outbound direction. When there is no access point signal present, the amplification direction will be from the structural wiring 201 to the access point 100.

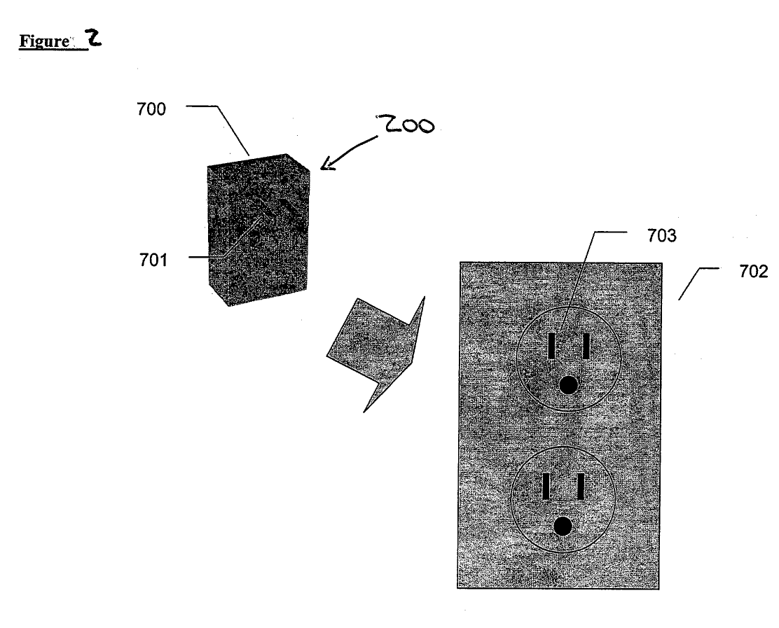

FIG. 2 shows the interface unit 200 in exemplary form. The interface unit 200 includes an electronics housing 700, and is powered by and coupled to the structural wiring 201 in FIG. 1 via a well known power plug connecter 701. More specifically, the prongs of the power plug connector 701 are insertable into a power receptacle 703 of a conventional wall power outlet 702 to which the structural wiring 201 (FIG. 1) is connected.

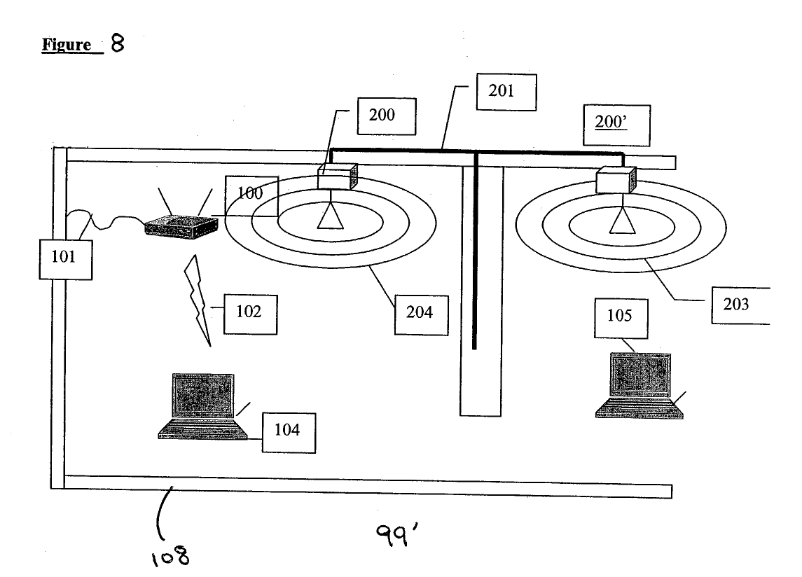

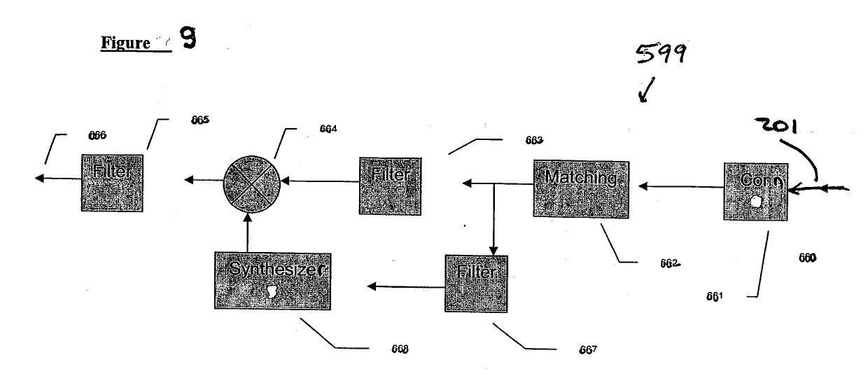

Referring to FIG. 3, components of a bi-directional amplification circuit 599 are shown. These components are contained within the electronics housing 700 shown in FIG. 3. Specifically, an antenna 600 is for receiving a WLAN RF signal and a detector 603 is for detecting the presence of the RF signal by comparing power levels on either side of the amplification circuit 599. The detector 603 may also compare the value of a detected signal with an absolute threshold, which may be relative to, for example, thermal noise or ambient noise. When the detector 603 does detect the presence of the RF signal, a selector 604, which may be a settable switch well known to those skilled in the art, sets an amplifier module 601 to amplify the RF signal on the structural wiring 201 in a predetermined direction. The amplified RF signal is then coupled to the structural wiring 201 by cable interface electronics 602, which are described in detail below in association with FIG. 8. When the RF signal is present at the structural wiring 201 rather than at the antenna 600, meaning that the RF signal is being received from the structural wiring 201, the detector 603 sets the selector 604 to amplify the RF signal in a direction opposite to that described above and to transmit the amplified RF signal on the antenna 600.

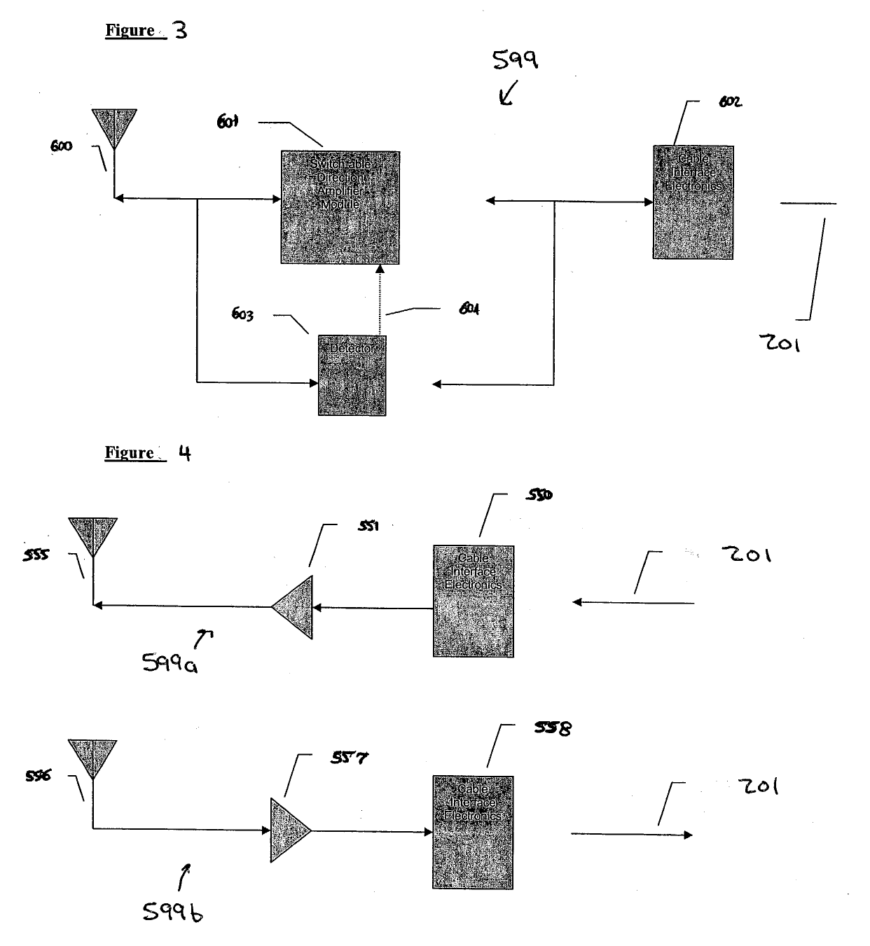

Referring now to FIG. 4, two separate bi-directional amplification circuits 599a, 599b may be used instead of the single bi-directional amplification circuit 599 in FIG. 3. In FIG. 4, the bi-directional amplification circuit 599a is, for example, a transmitting bi-directional amplification circuit, while the bi-directional amplification circuit 599b is, for example, a receiving bi-directional amplification circuit relative to the structural wiring 201.

In this exemplary configuration, in the bi-directional amplification circuit 599b, an RF signal is received on an antenna 556 from the access point 100 or from the network device 105 (FIG. 1). The RF signal is coupled from the antenna 556 to the amplifier 557 where it is amplified. The RF signal is then passed through cable interface electronics 558 and then to structural wiring 201.

In the bi-directional amplification circuit 599a, the RF signal received from the structural wiring 201 is coupled to cable interface electronics 550 and then amplified by an amplifier 551. The amplified RF signal is then coupled to an antenna 555 for transmission to the access point 100 (FIG. 1) or to another WLAN device.

Turning now to FIG. 5, the bi amplifier module 601 of FIG. 3 is shown in more detail. When the selector 604 is set for left to right amplification, switches 501, 503 are set such that an RF signal at an input/output 500 is coupled to an amplifier 505 and then to an input/output 504. When the selector 604 is set for right to left amplification, the switches 501, 503 are set such that the RF signal at the input/output 504 is coupled to an amplifier 502 and then to the input/output 500.

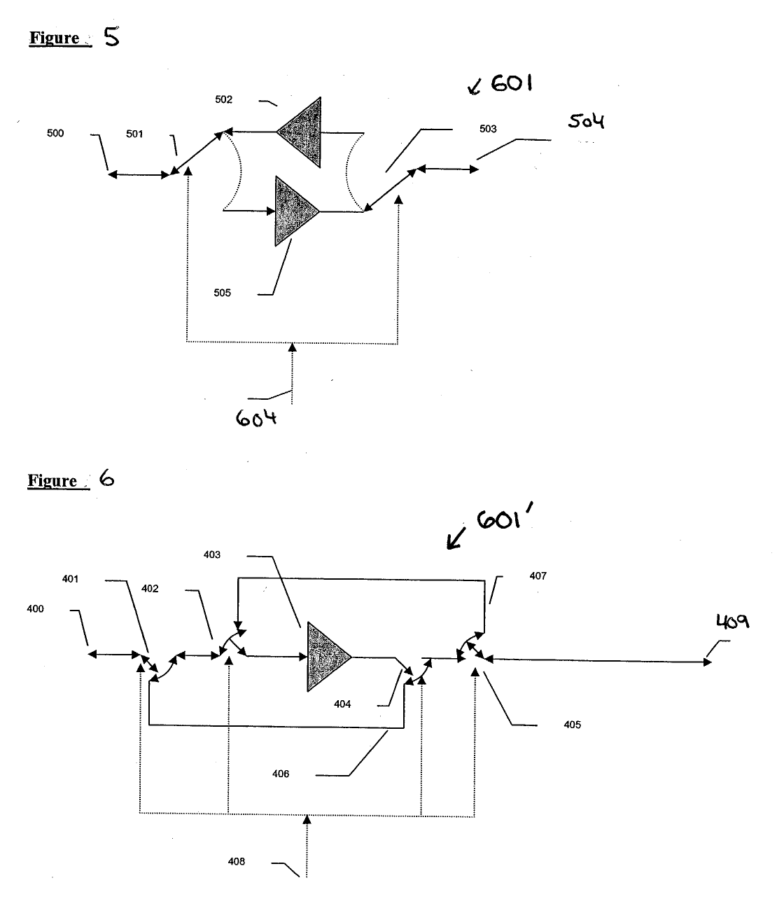

In an alternative amplifier module 601′ shown in FIG. 6, more switches may be used so that a single amplifier may be used for multiple paths. For example, when a control line 408 corresponding to the selector 604 in FIGS. 3 and 5 is set for left to right amplification, switches 401, 402 are set to couple the RF signal input from input/output 400 to an amplifier 403. Switches 404, 405 are then set to couple the RF signal output from the amplifier 403 to an input/output 409.

When the selector line 408 is set for right to left amplification, the switches 401, 402, 404, and 405 are set so that the RF signal is input into the amplifier 403 over trace 407. The amplified RF signal is then output over trace 406 to the input/output 400.

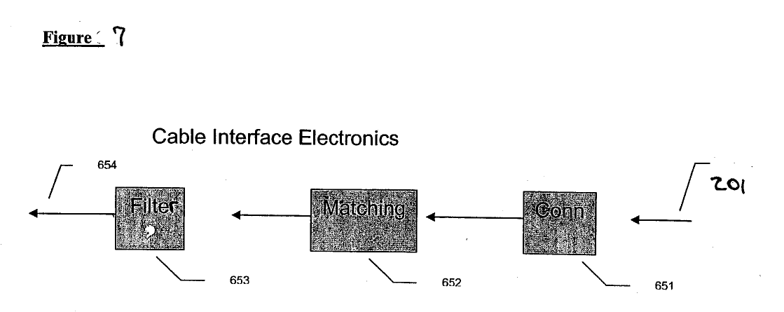

FIG. 7 shows exemplary components of the cable interface electronics 602, 550, 558 of FIGS. 3 and 4 in more detail. The cable interface electronics provide a connection and impedance matching function between the amplification circuits and the structural wiring 201. In FIG. 7, the structural wiring 201 is connected to an interface connector 651, which could be the prongs of the power plug connector 701 shown in FIG. 2. The RF signal is then matched using a matching circuit 652 before being coupled to a filter 653. The matching circuit 652 is well known to those of ordinary skill in the art and allows for the best and most efficient transfer of the RF signal to and from the structural wiring 201 and the cable interface electronics. Matching impedance is typically set based on pre-known cable impedance values. For instance, coaxial cable impedance is known to be 75 Ohms. The filter 653 removes unwanted out of band noise from the RF signal to be transferred to or from the amplification circuits via cable interface electronics output 654, and is also well known to those of ordinary skill in the art. The bandwidth of the filter is simply matched to the desired RF or IF band of interest, such as 802.11, and excludes or attenuates signals outside that band.

Referring now to FIG. 8, an exemplary wireless local area network (WLAN) 99′ is essentially the same as that shown FIG. 1 except that an additional interface unit 200′ is included. The interface unit 200′ couples the RF signal from the structural wiring 201 to an RF path or connection 203. The RF signal is passed to and/or from the RF connection 203 by another network device 105. In this manner, a second interface unit 200′ further extends the WLAN 99′.

The interface units 200, 200′ may be designed to amplify an RF signal in one or both directions to or from the network device 105. If the interface units 200, 200′ are designed to perform both functions, the amplification circuit may only be enabled in one direction at a time based on power threshold detection as described above. The transmitted signal from the access point 100 will trigger the amplification process in the outbound direction. When there is no access point signal present, the amplification will be triggered in a direction from the antenna 600 (FIG. 3) to the structural wiring 201.

Referring to FIG. 9, when an intermediate frequency is used to pass the signals over the structural wiring 201, the interface unit 200 may provide an up/down conversion function as well. FIG. 9 shows the up conversion function as, for example, IF signals are passed from the structural wiring 201 over a connector 661. The IF signal is then coupled to matching electronics 662. Next, a LO frequency is generated by obtaining the 60 Hz power signal from the structural wiring 201 as a reference for a phase locked loop or other well known synthesizer. This is done by obtaining the power signal from the matching circuit 662, filtering it in a filter 667 and synthesizing the LO via a synthesizer 668. The IF signal is then also coupled from the matching circuit 662 to the filter 663 and then up (or down converted) by a frequency converter 664. The output of the frequency converter 664 is connected to a filter 665 and then to input/output 666. Alternatively, the IF signal may be passed in the other direction, from the input/output 666 to the structural wiring 201 using the same process.

The invention has been described in detail with particular references to presently preferred embodiments thereof, but it will be understood that variations and modifications can be effected within the spirit and scope of the invention.

What is claimed is:

1. A wireless area network including at least one access point and providing for multiple possible network devices, the wireless area network further being located in a structure with wiring, comprising:
an interface unit for receiving a wireless signal from the access point and transmitting the wireless signal on the wiring, or for receiving the wireless signal from the wiring and transmitting the wireless signal to the access point.

2. The wireless area network of claim 1, wherein the wiring is selected from a group consisting of Ethernet cable, power lines, CAT5 cable, television cable, coaxial cable, and telephone wires.

3. A wireless local area network interface unit for use in proximity to structural wiring, comprising:
an antenna for receiving a wireless signal;
an amplifier connected to an output of the antenna for amplifying the wireless signal;
an impedance matching circuit connected to an output of the amplifier and for matching an impedance of the structural wiring; and
a connecter for receiving an output of the impedance matching circuit and passing the wireless signal received by the antenna onto the structural wiring.

4. The wireless local area network interface unit of claim 3, further comprising a switch connected between the impedance matching circuit and the amplifier for reversing a signal transmission direction.

5. The wireless local area network interface unit of claim 4, wherein the switch is selectable to disconnect the output of the antenna from an input of the amplifier, and for connecting the output of the impedance matching circuit to the input of the amplifier, and the output of the amplifier to an input of the antenna.

6. The wireless local area network interface unit of claim 5, further comprising a signal detector for determining if the wireless signal is being received by the antenna, and for connecting the output of the antenna to the input of the amplifier to cause the wireless signal received at the antenna to be passed to the power line connector.

7. The wireless local area network interface unit of claim 6, wherein the signal detector is further for determining if a high frequency signal comprising the wireless signal is present at the connecter, and for causing the switch to connect the input of the antenna to the output of the amplifier to pass the wireless signal to the antenna.

8. The wireless local area network interface unit of claim 3, further comprising an intermediate frequency converter operably connected to the wireless signal received by the antenna to reduce a frequency of the wireless signal transmitted to the connector.

9. A range extending interface unit for a wireless local area network located in proximity to structural wiring, comprising:
a wiring connector for electrically interfacing with the wiring;
an antenna for receiving wireless communication signals;
a signal detector in communication with both the wiring connector and the antenna for receiving the wireless communication signals from the antenna and the wiring connector;
an amplifier connected to the antenna and the wiring connector for amplifying the wireless communication signals received therefrom; and
a switch circuit connected to the signal detector and the amplifier for connecting an output of the antenna to an input of the amplifier and an output of the amplifier to an input of the wiring connector when the wireless communication signals are detected at the antenna by the signal detector, and for connecting an output of the wiring connector to the input of the amplifier and the output of the amplifier to an input of the antenna when a signal is detected at the wiring connector.

10. The range extending interface unit of claim 9, wherein the wiring connector further includes an impedance matching circuit for matching an impedance of the structural wiring.

11. The range extending interface unit of claim 9, further comprising a filter having a bandwidth matched to a frequency of the wireless communication signals received by the antenna for attenuating frequencies outside the bandwidth.

12. The range extending interface unit of claim 9, wherein the wireless communication signals are transmitted at a frequency in compliance with an 802.11 standard.

13. An interface unit for extending a range of communication in a wireless local area network, when operating in proximity to structural wiring, comprising:
an antenna for receiving wireless communication signals;
a wiring connector for electrically interfacing with the wiring;
a signal detector connected to the antenna and to the wiring connector for receiving the wireless communication signals when provided from the antenna and the wiring connector;
a first amplifier for amplifying the wireless communication signals when received from the antenna and for passing the wireless communication signals once amplified to the wiring connector;
a second amplifier for amplifying the wireless communication signals when received from the wiring connector and for passing the wireless communication signals once amplified to the antenna; and
a switch connected to the signal detector and the first and second amplifiers for enabling the first amplifier when a signal is detected at the antenna by the signal detector and for enabling the second amplifier when a signal is detected at the wiring connector.

14. An interface connector for extending a range of communication in a wireless local area network located near wiring, comprising:
an interface cable for receiving/transmitting wireless communication signals from/to an access point;
a wiring connector for electrically interfacing with the wiring;
a signal detector in communication with both the interface cable and the wiring connector for receiving the wireless communication signals from the interface cable and the wiring connector;
a first amplifier for amplifying the wireless communication signals received from the interface cable and for passing the wireless communication signals once amplified to the wiring connector;
a second amplifier for amplifying the wireless communication signals received from the wiring connector and for passing the wireless communication signals once amplified to the interface cable.
